(19) United States
(12) Patent Application Publication
(10) Pub. No.: US 2018/0221863 A1
(43) Pub. Date: Aug. 9, 2018

(54) PIPETTE TIPS WITH ENHANCED ATTRIBUTES AND METHODS FOR MANUFACTURING

(71) Applicant: CORNING INCORPORATED, Corning, NY (US)

(72) Inventors: John Claude Cadotte, JR., Waterboro, ME (US); Michael Patrick Keenan, Londonderrt, NH (US); David Alan Kenney, Greenville, NH (US); Aravind Raghavan Rammohan, Big Flats, NY (US); Joseph Christopher Wall, Southborough, MA (US); Jin Wang, Ithaca, NY (US)

(21) Appl. No.: 15/504,553

(22) PCT Filed: Aug. 20, 2015
(86) PCT No.: PCT/US2015/046081

§ 371 Date: Feb. 16, 2017

Related U.S. Application Data
(60) Provisional application No. 62/039,491, filed on Aug. 20, 2014.

(51) Int. Cl. B01L 3/02

(52) U.S. Cl. CPC B01L 3/0275; B01L 2200/12; B29C 45/27; B01L 2300/0848; B01L 2300/12; B01L 2300/0832

(57) ABSTRACT

A pipette tip includes a proximal end having an aperture and a proximal body region having a first internal cavity that receives a pipette member, and a distal end having an aperture and a distal body region having a second internal cavity that in operation receives and discharges a liquid aspirated by the pipette member, where the ratio of the proximal half weight of the pipette tip to the distal half weight of the pipette tip normalized to the total weight of the pipette tip has a value, defined as a thinning constant, wherein the pipette tip has a wall thickness of less than 0.022 inches over the distal region.

This application claims the benefit of priority under 35 U.S.C. § 119 of U.S. Provisional Application Ser. No. 62/039,491 filed on Aug. 20, 2014 the content of which is relied upon and incorporated herein by reference in its entirety.

### BACKGROUND

### Field

The present disclosure relates generally to disposable pipette tips and methods for making such pipette tips, and particularly to pipette tips having enhanced attributes and improved manufacturability.

### Technical Background

Manipulation of biological and/or chemical molecules in solution has become an essential aspect of various kinds of analysis. In biomedical or pharmaceutical assays, for example, cellular components, proteins or nucleic acid (DNA) molecules are studied to ascertain particular genetic risk factors for disease or the efficacy of drug trials. Pipettes are commonly used as a vehicle for such manipulations.

Disposable pipette tips were introduced to help laboratories avoid cross-contamination that is associated with reusing pipettes. Such pipette tips are typically made from polypropylene via injection molding. Disposable pipette tips are attached to the distal end of mechanical aspirators, i.e., the mandrel shaft of a pipettor, and are designed to fit on the end of the mechanical aspirator so that the sole air path from the mechanical aspirator is out through the distal end of the pipette tip. Prior to the distal end being inserted into a fluid to be aspirated from a source container, the mechanical aspirator typically uses a plunger to advance air through the aspirator and out the pipette tip's distal end. After the distal end is placed in the fluid, the plunger on the mechanical aspirator is released to introduce a relative vacuum into the pipette tip and thereby draw fluid from the source container into the pipette tip. The aspirated fluid contained in the pipette tip can then be dispensed into a target container using the plunger. Recently, robotic aspirating instruments have come to replace manual mechanical aspirators, especially in high throughput and labor intensive environments.

It would be advantageous to have a methodology to design and manufacture disposable pipette tips and particularly to design economical pipette tips having attributes compatible with existing infrastructure and suitable for use with both manual and robotic handlers.

### BRIEF SUMMARY

Disclosed are methods for generating pipette tip designs where the pipette tips exhibit one or more enhanced attributes, as well as pipette tips having such attributes. In embodiments, these enhanced attributes include a thinned profile to reduce the amount of resin used to form the pipette tip. In embodiments, the distal end of the pipette tip is thinned in a way that allows the tip to maintain rigidity necessary to use the pipette tip without causing it to bend. In embodiments, the pipette tip is thinned so that the ratio of the weight of the proximal end of the pipette tip to the distal end of the pipette tip, compared to the overall weight of the pipette tip, creates a tip that is reduced in weight in the distal portion of the pipette tip.

In embodiments, the pipette tip includes a proximal end having an aperture and a proximal body region having a first internal cavity that receives a pipette member; and a distal end having an aperture and a distal body region having a second internal cavity that in operation receives and discharges a liquid aspirated by the pipette member. The proximal body region is juxtaposed to the distal body region, and the respective proximal first and distal second internal cavities are in gas-liquid communication, wherein the pipette tip has a wall thickness of less than 0.022 inches over the distal body region. A method of making a pipette tip comprises injecting a suitable polymer into a single or multiple cavity mold.

Additional features and advantages of the subject matter of the present disclosure will be set forth in the detailed description which follows, and in part will be readily apparent to those skilled in the art from that description or recognized by practicing the subject matter of the present disclosure as described herein, including the detailed description which follows, the claims, as well as the appended drawings.

It is to be understood that both the foregoing general description and the following detailed description present embodiments of the subject matter of the present disclosure, and are intended to provide an overview or framework for understanding the nature and character of the subject matter of the present disclosure as it is claimed. The accompanying drawings are included to provide a further understanding of the subject matter of the present disclosure, and are incorporated into and constitute a part of this specification. The drawings illustrate various embodiments of the subject matter of the present disclosure and together with the description serve to explain the principles and operations of the subject matter of the present disclosure. Additionally, the drawings and descriptions are meant to be merely illustrative, and are not intended to limit the scope of the claims in any manner.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a perspective view of a pipette tip according to various embodiments;

FIG. 2 is a cross-sectional view of the pipette tip shown in FIG. 1;

FIG. 3 is (A) an optical micrograph of an example pipette tip; (B) a modeled image of a prior art pipette tip (A Prior Art); (C) a modeled image of a redesigned pipette tip according to one embodiment; and (D) a modeled image of a redesigned pipette tip according to a further embodiment;

FIG. 4 is a schematic perspective view of an experimental pipette tip highlighting select design changes relative to a Prior Art pipette tip (A (Prior Art);

FIG. 5 is a top-down view of a pipette tip, taken from the proximal end of the pipette tip;

FIG. 6 is a schematic lateral view of (A, D) experimental thin-walled pipette tips, and (B, C) prior art pipette tips;

FIG. 7 is an engineering drawing showing a lateral view of an embodiment of the experimental thin-walled pipette tip.

FIG. 8 is an engineering drawings showing a cross-sectional view of an embodiment of the experimental thin-walled pipette tip, taken at line A-A of FIG. 7;

FIG. 9 is an engineering drawing showing an expanded view of an embodiment of the experimental thin-walled pipette tip, shown in the circle of FIG. 8;

FIG. 10 is an engineering drawing showing a cross-sectional axial view of an embodiment of the experimental thin-walled pipette tip of FIG. 7;

FIG. 11 is a graph showing post-molding, through-thickness shrinkage variation in each of an embodiment of the experimental thin-walled pipette tip and a prior art pipette tip;

FIG. 12 is a graph showing crystallite size in an embodiment of an experimental thin-walled pipette tip and a prior art pipette tip;

FIG. 13 is an optical micrograph of an embodiment of an experimental thin-walled pipette tip and a prior art pipette tip;

FIG. 14 shows SEM micrographs of the interior surface of an embodiment of an experimental thin-walled pipette tip and a prior art pipette tip;

FIG. 15 is a perspective view of an experimental thin-walled pipette tip according to further embodiments;

FIG. 16 is a perspective view of an an experimental thin-walled pipette tip according to further embodiments;

FIG. 17 is a perspective view of a ribbed thin-walled pipette tip according to further embodiments;

FIG. 18 is a perspective view of an experimental ribbed thin-walled pipette tip according to further embodiments;

FIG. 19 is an engineering drawing showing a lateral view of an embodiment of an experimental thin-walled pipette tip of FIG. 16;

FIG. 20 is an engineering drawing showing a cross-sectional view of the experimental pipette tip of FIG. 16;

FIG. 21 is an engineering drawing showing a cross-sectional view of the experimental pipette tip of FIG. 16;

FIG. 22 is an engineering drawing showing a cross-sectional view of the experimental pipette tip of FIG. 16 according to embodiments;

FIG. 23 is an engineering drawing showing a lateral view of the ribbed thin-walled pipette tip of FIG. 17;

FIG. 24 is an engineering drawing showing a cross-sectional view of the experimental pipette tip of FIG. 17;

FIG. 25 is an engineering drawing showing an axial view of the experimental pipette tip of FIG. 17;

FIG. 26 is an engineering drawing showing a magnified cross-sectional view of the experimental pipette tip of FIG. 27;

FIG. 27 is a schematic illustration of a hot runner system for manufacturing thin-walled pipette tips, according to embodiments of the invention;

FIG. 28 is a graph illustrating the proximal half-tip weight of an experimental embodiment compared to prior art pipette tips.

FIG. 29 is a graph illustrating the distal half-tip weight of experimental embodiment compared to prior art pipette tips.

FIG. 30 is a graph illustrating the Thinning Constant T plotted against total weight (Wt) for an experimental embodiment compared to prior art pipette tips.

FIG. 31 is a measurement of changes in mass, indicating the resistance to, and retention of water on an experimental and a prior art tip.

### DETAILED DESCRIPTION

Reference will now be made in greater detail to various embodiments of the subject matter of the present disclosure, some embodiments of which are illustrated in the accompanying drawings. The same reference numerals will be used throughout the drawings to refer to the same or similar parts.

Embodiments relate to an integrated computational approach to generate and assess new pipette tip designs. Particularly attractive are economical pipette tip designs, such as designs that utilize less raw material. The approach involves: (i) generating a new pipette design, (ii) evaluating the moldability of the design (e.g., injection pressure, core shift), (iii) evaluating the structural reliability of the design (e.g., bending, mandrel insertion, filter insertion), (iv) optimizing manufacturing process settings (e.g., warp, deflection, straightness as well as choice of resin), and (v) evaluating compatibility with after-mold processes. The design generation and evaluations may be performed using a mathematical model, which minimizes the risks of going to production with unsuitable or inefficient new designs.

The manufacture (e.g., injection molding) of pipette tips comprising less raw material, i.e., thin walls, poses a number of challenges. In the molding process, a thin mold cavity is more difficult to fill than a thick counterpart. Notably, due to the pressure drop being inversely proportional to the square of the wall thickness, injection into a thin mold cavity requires a high injection pressure. Pipette tip designs having thin walls should be injection moldable within machine capacity. In addition, the molded part should be free of visual defects and core deflection should be small. Injection molding simulation using Autodesk Simulation Moldflow Insight software is conducted to evaluate the moldability of thin designs.

In addition to the manufacturing challenges associated with a thin walled design, a thin part is typically less stiff and more flexible than a thick part. When mounted onto a robotic system, pipette tips should sustain the abrupt insertion of a mandrel shaft and then tightly grip onto it. During liquid transportation, pipette tips should withhold the liquid and not wobble. In embodiments where the pipette tip is fitted with an internal filter, the filter insertion should not cause deformation or damage to the tip. Structural analysis models account for all three normal operations, and were used to evaluate the reliability of thin walled designs as disclosed herein.

In addition to the foregoing, injection molded parts tend to shrink and warp as a result of the molding process. The generation of residual stresses during molding and the post-molding relaxation of such stresses due to thermal cycling may introduce deformation into a finished part. For example, pipette tips are optionally sterilized in an autoclave after molding. Elevated temperatures associated with the sterilization process may relieve internal stresses that result in measureable strain. Also, stress creep may be observed in tips shipped to hotter climates. Several after-molding processes are modeled by the instant computational approach.

In embodiments, the final pipette tip meets one or more quality control specifications including, for example, weight, length, straightness, dimensional accuracy at the mandrel engagement location, roundness of the small orifice, and optical clarity. In embodiments, the improved designs are compatible with existing pipette infrastructure.

In various embodiments, the inner diameter (ID) of the redesigned pipette tip is retained, while the outer diameter (OD) is reduced with respect to conventional designs. This can result in a substantial decrease is material utilization with attendant decreases in part weight and production cost while unexpectedly resulting in a mechanically robust part. Reduction in the outer diameter may be uniform over the length of the pipette tip or non-uniform, i.e., localized.

In embodiments, the circumferential thickness of reinforcing fins located at a proximal end of the pipette tip is decreased to further decrease material utilization. In embodiments, the fin height as measured in the radial direction is unchanged with respect to conventional designs.

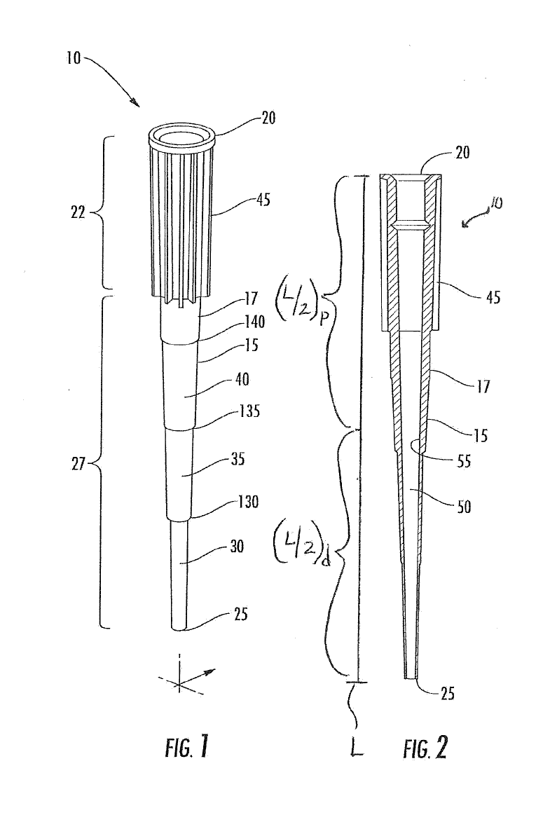

With reference to FIG. 1, in embodiments, and experimental disposable pipette tip 10 is illustrated, includes an open cannula 15 having a tapering conical shape defined by a cylindrical outer wall 17. Cannula 15 includes an open proximal end 20 with a proximal body region 22 (i.e., a “head” or “collar”) that receives a pipette member (e.g., pipette mandrel); and an opposing open distal end 25 with a distal body region 27 (i.e., “a liquid tip”). Cannula 15 includes a plurality of optional annular gradations 130, 135 and 140 on outer wall 17 therebetween. Cannula 15 also optionally includes a plurality of fins 45 projecting from outer wall 17 and extending longitudinally from proximal end 20 towards distal end 25. Fins 45 or radial fins 45 are provided to support the disposable pipette tip 10, such as when attaching pipette tip 10 to an aspirating instrument.

Optional gradations 130, 135 and 140 may be present to divide cannula 15 into sections 30, 35 and 40 with each gradation 130, 135 and 140 representing a predetermined volume of liquid that may be located between the respective gradation and distal end 25 within cannula 15. These gradations may be used by laboratory workers when visually measuring the volume of aspirated liquid during a manual pipetting operation. The total volume of liquid that can be held in this usable portion of pipette tip 10 may range from about 0.5 μL to 250 mL, e.g., 0.5, 1, 5, 10, 50, 100, 250, 500, 1000, 2000, 5000, 10000, 20000, 50000, 100000 or 250000 μL. Of course, the above-noted volumes are merely exemplary; the present disclosure will also work and be very beneficial for pipette tips having larger and smaller volumes with or without gradations.

FIG. 2 is a cross-sectional view of an embodiment of an experimental pipette tip 10, shown in FIG. 1 and shows a passageway 50 with a generally tapering conical shape extending from proximal end 20 to distal end 25. As shown in FIG. 2, passageway 50 is defined by an interior wall 55 having a diameter. The pipette wall may have a constant thickness or, as illustrated, a variable thickness that decreases (e.g., monotonically) from proximal end 20 to distal end 25. FIG. 2 also illustrates that the pipette tip has a length L. Length L can be divided into a proximal half (L/2)p and a distal half (L/2)d.

During use, pipette tip 10 is attached to the distal end of an aspirating instrument and held in place by friction. When transferring a liquid reagent or sample from a source container to a target container, the distal end of the aspirating instrument with pipette tip 10 thereon is lowered into the fluid to be aspirated. As the disposable pipette tip is lowered into the fluid, the aspirating instrument generates an air flow through pipette tip 10. In embodiments, the air flow is monitored by a controller to detect a change in air flow when distal end 25 of pipette tip 10 enters the fluid. When a decrease in air flow is sensed, the aspirating instrument can determine that pipette tip 10 has entered the fluid and can begin an aspiration process, wherein a vacuum is applied to proximal end 20 to aspirate fluid through distal end 25 of pipette tip 10 and into passageway 50. The vacuum is applied until a predetermined volume of fluid has been aspirated into passageway 50. The aspirating instrument then extracts pipette tip 10 from the fluid source and moves pipette tip 10 to the target container to dispense the aspirated fluid.

When the aspirating instrument has positioned pipette tip 10 over the target container, air pressure is applied to proximal end 20 to dispense a volume of fluid in passageway 50 into the target container. After dispensing the fluid into the target container, the aspirating instrument ejects pipette tip 10 from its distal end into a disposal container.

An example method of using the pipette tip comprises inserting a pipettor mandrel shaft into the first internal cavity to form a liquid-air seal between the pipette tip and the shaft, receiving a liquid into the second internal cavity and thereafter dispensing the liquid out of the second internal cavity, and separating the pipette tip from the pipettor mandrel shaft.

The following examples are illustrative of various embodiments, and include the disclosure of pipette tip designs having one or more enhanced attributes.

### Examples

Predictive modeling was used to generate improved designs with favorable attributes. Experimental embodiments were generated, designated as BT-250 or BT-250 (thin) (Version 1 and Version 2) in a 250 μl pipette tip embodiment, and ZT200 or ZT200 (Thin) in a 200 μl pipette tip embodiment. Existing 250 μl pipette tips and 200 μl pipette tips were used as benchmarks, as shown in Table 1.

TABLE 1

| | Description |
|---|---|
| BT-250 or BT- | Experimental 250 μl tip |
| 250 (thin) | |
| ZT-200 or ZT-200 | Experimental 200 μl tip |
| (thin) | |
| A (Prior Art) | 250 μl tip available from Axygen, Inc., |
| | Union City, CA. |
| A200 (Prior Art) | 200 μl tip available from Axygen, Inc., |
| | Union City, CA. |
| B (Prior Art) | 250 μl tip available from Beckman |
| | Coulter, Brea, CA |
| M (Prior Art) | 250 μl pipette tip available from Molecular |
| | Bio Products available from |
| | ThermoFisher, Waltham MA. |

Referring to FIG. 3, a design image for a conventional (BT-250) pipette tip (FIGS. 3A and 3B) is shown together with one embodiment of an experimental pipette tip (BT-250 thin, Version 1) in FIG. 3C and a further embodiment of an experimental pipette tip (BT-250 (Thin), Version 2) FIG. 3D. As seen with reference to FIG. 3C, removal of too much material from the circled distal region of the experimental pipette tip (BT-250 thin, Version 1) resulted in unacceptable bending or crimping along the tip length. However, as shown in FIG. 3D, in the further embodiment of the experimental pipette tip (BT-250 (Thin), Version 2), bending or crimping did not occur upon introduction of the same bending force. For purposes of this disclosure, the experimental pipette tip BT-250 (thin) described throughout is the Version 2 experimental pipette tip. As shown in FIG. 3D, resin utilization is decreased by 40% relative to the conventional design, A (Prior Art), shown in FIG. 3B. In embodiments, the pipette tips have a total length of from about 1.75 to 2.4 inches, e.g., about 1.75, 1.76, 1.77, 1.78, 1.79, 1.8, 1.81, 1.82, 1.83, 1.84, 1.85, 1.86, 1.87, 1.88, 1.89, 1.90, 1.91, 1.92, 1.93, 1.94, 1.95, 1.96, 1.97, 1.98, 1.99, 2, 2.01, 2.02, 2.03, 2.04, 2.05, 2.06, 2.07, 2.08, 2.09, 2.01, 2.02, 2.03, 2.04, 2.05, 2.06, 2.07, 2.08, 2.09, 2.1, 2.11, 2.12, 2.13, 2.14, 2.15, 2.16, 2.17, 2.18, 2.19, 2.2, 2.21, 2.23, 2.24, 2.25, 2.26, 2.27, 2.28, 2.29, 2.3, 2.31, 2.32, 2.33, 2.34, 2.35, 2.36, 2.37, 2.38, 2.39 or 2.4 inches, including ranges between any of the foregoing, and comprise a total resin volume of from about 190 to 220 mm³, e.g., about 190, 195, 200, 205, 210, 215 or 220 mm³, including ranges between any of the foregoing. For example, the example tip may be from 1.75 to 2.25 inches or from 1.75 to 2.4 inches.

In embodiments, the BT-250 pipette tip (Version 2, as illustrated in FIG. 3D) has a tip straightness differential length of about 0.0005 in, in embodiments. The tip straightness differential length (l) is defined as L(1−cos θ), where L is the overall length of the pipette tip and θ is the average angle of tip deflection. Thus, the tip straightness differential length (l) is the difference between the unbent length (L) of the pipette tip and the horizontal projection of the pipette tip length when the tip is bent, i.e., in the absence of an applied load or in response to a constant load (e.g., 0.4 to 2 N) applied to the distal end of the tip in a direction orthogonal to the tip length (L). For an un-deflected (straight) tip, θ=0 and l=0.

In embodiments, pipette tips have a tip displacement of less than 2 mm, e.g., 0.8, 0.9, 1.0, 1.1, 1.2, 1.3, 1.4, 1.5 or 1.6 mm, and a tip straightness differential length between 0 and 0.040 inches, e.g., 4×10⁻², 2×10⁻², 1×10⁻², 5×10⁻³, 2×10⁻³, 1×10⁻³, 5×10⁻⁴, 2×10⁻⁴, 1×10⁻⁴, 5×10⁻⁵ or 0 inches, including ranges between any of the foregoing. In further embodiments, pipette tips have a tip displacement for an applied load of 0.4 N of less than 2 mm, e.g., 0.8, 0.9, 1.0, 1.1, 1.2, 1.3, 1.4, 1.5 or 1.6 mm, including ranges between any of the foregoing. In further embodiments, pipette tips have a tip displacement for an applied load of 1 N of less than 4 mm, e.g., 1, 1.5, 2, 2.5, 3, 3.5 or 4 mm, including ranges between any of the foregoing. In further embodiments, pipette tips have a tip displacement for an applied load of 2 N of less than 8 mm, e.g., 4, 5, 6, 7 or 8 mm, including ranges between any of the foregoing.

A tip straightness differential length of 0.0005 inches represents an improvement over conventional pipettes. The BT-250 embodiment has a tip straightness differential length of 0.0014 in. The improved tip straightness of the BT-250 thin embodiment minimizes pipette tip-dispenser mismatch and hence enhances ease of use.

In addition to stress-induced deformation (deflection), tips may undergo thermally-induced deformation or deflection due to, for example, thermal expansion during cooling. In embodiments, injection molded tips exhibit a core shift (tip displacement) of less than 10⁻³, 10⁻⁴, or 10⁻⁵ in. Core shift data for example pipette tips is summarized in Table 6. Additional beneficial attributes associated with the thin designs as disclosed herein, due at least in part to the decreased resin utilization, include an overall thinner platform, decrease in part shrinkage, and increase in optical clarity compared to conventional pipette tips. The increased optical clarity enhances the visibility of fluid within the pipette tip, and enables the use of additives such as anti-static chemistries that can improve fluid dispensing accuracy, but which may adversely contribute to transparency. In addition, the thinner platform enables the use of a broader array of additives at higher loading levels. Moreover, the thinner platform (decreased resin utilization) is achieved without compromising the mechanical integrity (i.e., tip straightness, tip stiffness, sealability, etc.) of the pipette tip. In one example, a 37% decrease in mandrel load force (from 23.4 lbf to 14.6 lbf) was realized with the thinner design. For manual pipetting, this reduces operator fatigue. For automated applications, it allows for lower cost mandrel drivers and decreases wear and tear on the components.

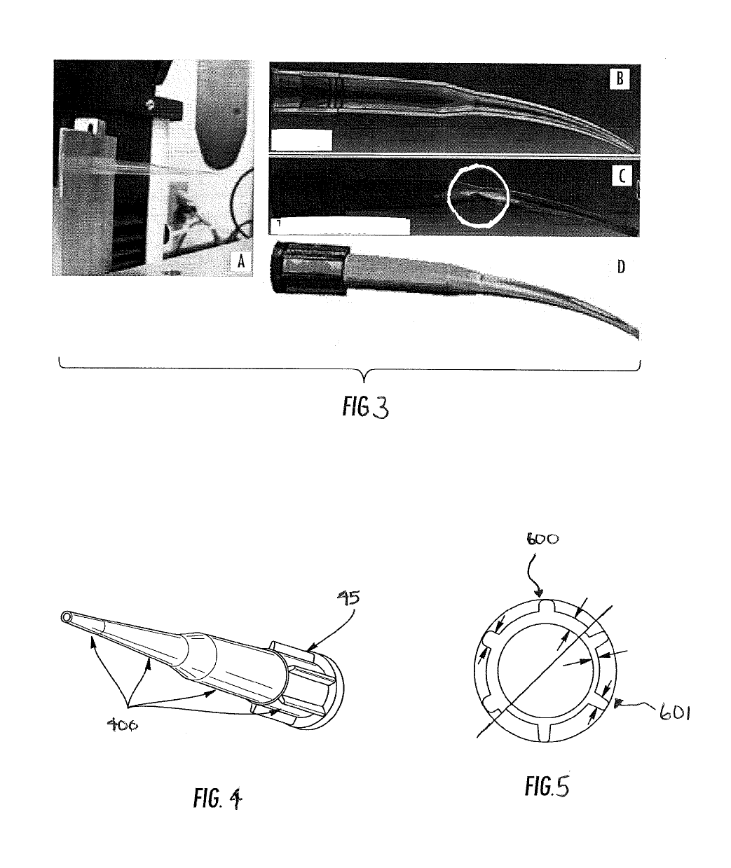

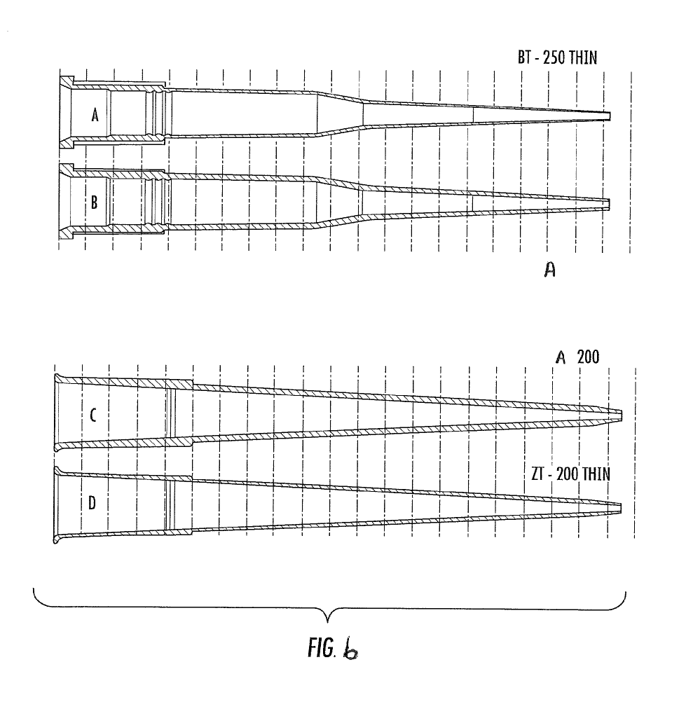

Highlighted in FIGS. 4 and 5 are areas where design changes were made in embodiments of the experimental BT-250 pipette with respect to the A (Prior Art) tip, which include decreasing the thickness of the outer wall and decreasing the circumferential thickness of the supporting fins. In embodiments, supporting fins have a circumferential thickness of less than 0.03 inches, e.g., 0.026 or 0.022 inches. FIG. 4 illustrates the outer diameters 400 of the pipette tip, in embodiments. FIG. 5 is a top-down view of a pipette tip, taken from the proximal end of the pipette tip. FIG. 5 illustrates the thickness of the experimental pipette tip BT-250 601 compared to the thickness of a prior art pipette tip, such as A (Prior Art) 600, in embodiments. The experimental pipette tip BT-250 shows a thinner wall thickness than the A (Prior Art) pipette tip.

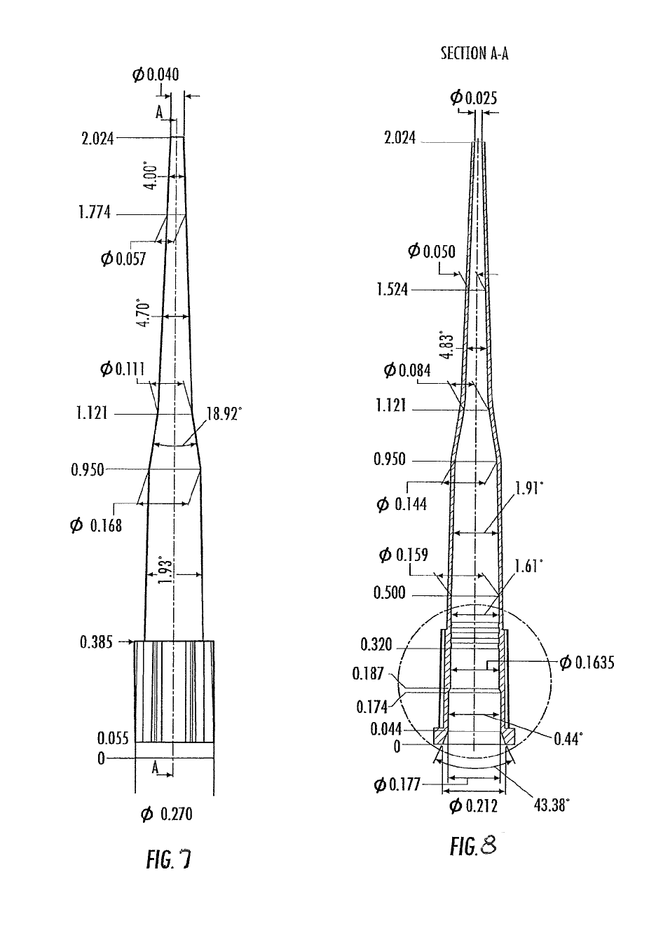

Summarized in Table 2 are pipette tip dimensions (inner diameter, wall thickness and outer diameter in units of inches) at discrete locations along the length of the pipette tip (at 0.1 inch intervals) from the proximal end to the distal end for each of the BT-250 thin (Version 2) (shown in FIG. 6A) and A (Prior Art) tips (shown in FIG. 6B). Also illustrated in FIG. 6 are corresponding cross-sectional drawings for the experimental ZT-200 thin designs (shown in FIG. 6C) as disclosed herein and the A200 (Prior Art) tips (shown in FIG. 6D). In FIG. 6, each 0.1 inch interval is delineated with a dashed vertical line.

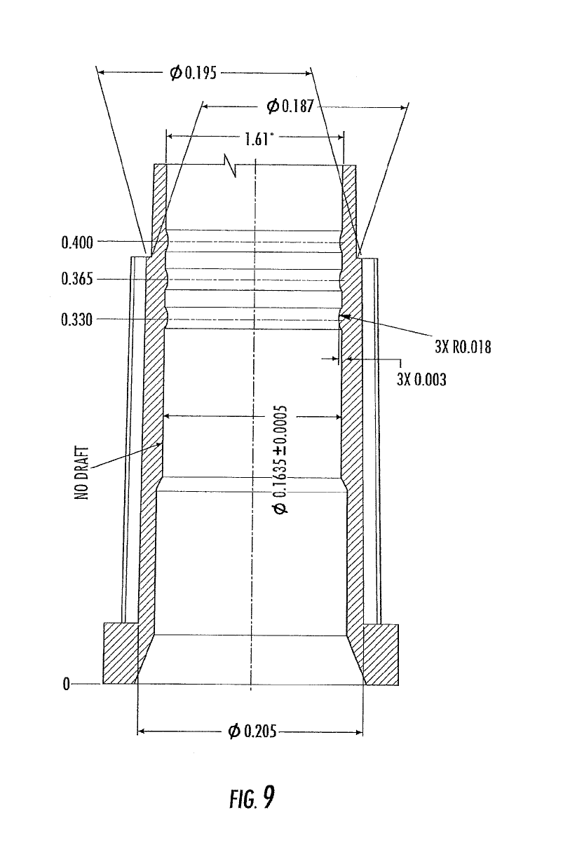

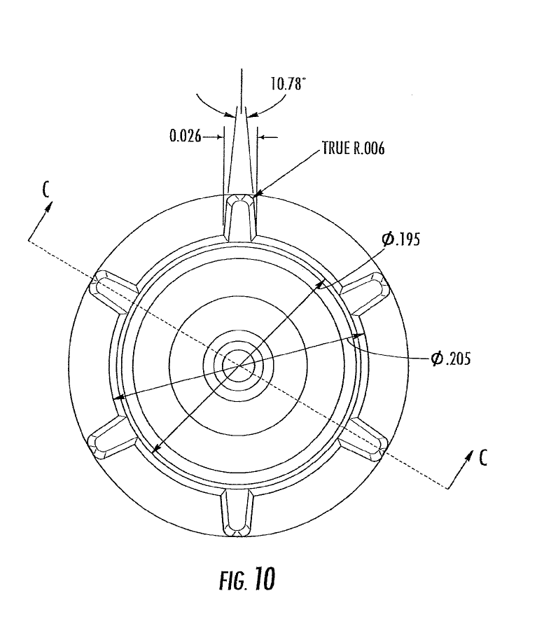

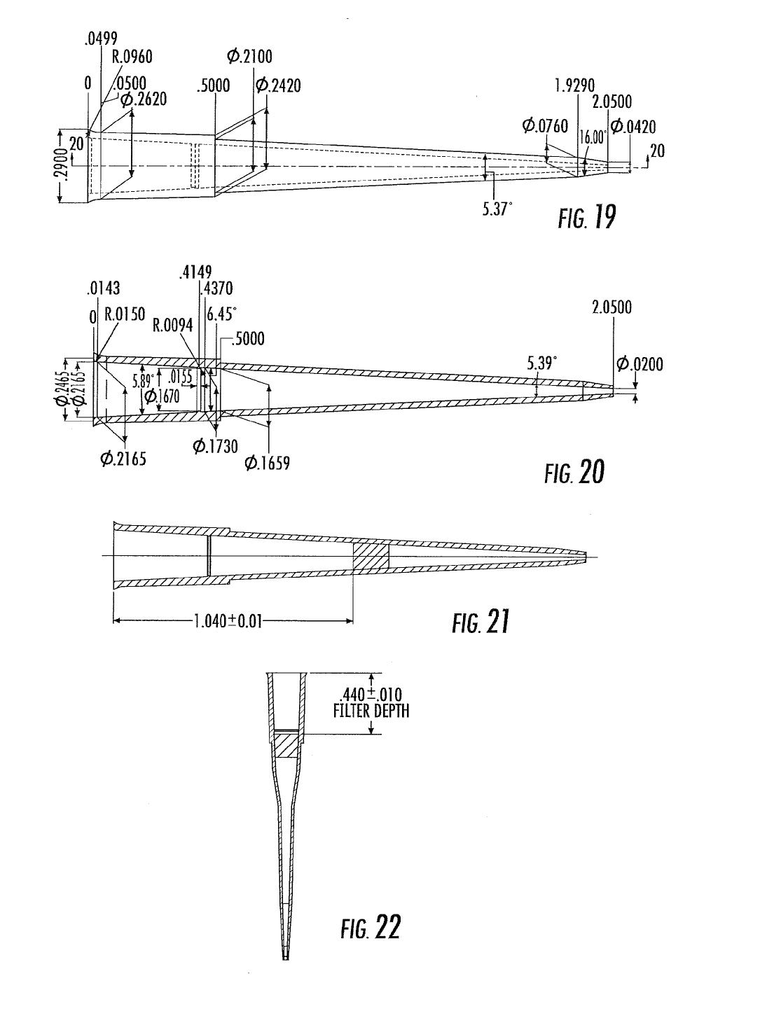

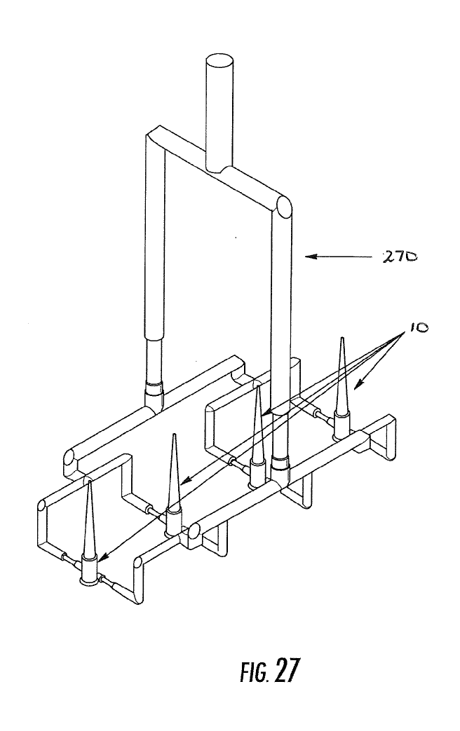

According to embodiments, engineering drawings for the BT-250 thin design (Version 2) are shown in FIGS. 7, 8, 9 and 10. Engineering drawings for the ZT-200 thin embodiment are shown in FIGS. 19-26. Length measurements in the engineering drawings are given in inches.

TABLE 2
BT-250 Pipette Tip Dimensions

| | BT-250 thin | | | A (Prior Art) | | |
|---|---|---|---|---|---|---|
| | ID | wall | OD | ID | wall | OD |
| Proximal End | 0.212 | 0.029 | 0.270 | 0.212 | 0.029 | 0.27 |
| 0.1 | 0.177 | 0.014 | 0.204 | 0.177 | 0.024 | 0.225 |
| 0.2 | 0.164 | 0.019 | 0.201 | 0.164 | 0.029 | 0.222 |
| 0.3 | 0.164 | 0.017 | 0.198 | 0.164 | 0.028 | 0.219 |
| 0.4 | 0.162 | 0.015 | 0.187 | 0.162 | 0.023 | 0.208 |
| 0.5 | 0.159 | 0.012 | 0.183 | 0.159 | 0.023 | 0.204 |
| 0.6 | 0.156 | 0.012 | 0.180 | 0.156 | 0.023 | 0.201 |
| 0.7 | 0.152 | 0.012 | 0.176 | 0.152 | 0.023 | 0.197 |
| 0.8 | 0.149 | 0.012 | 0.173 | 0.149 | 0.023 | 0.194 |
| 0.9 | 0.146 | 0.012 | 0.170 | 0.146 | 0.023 | 0.191 |
| 1 | 0.126 | 0.012 | 0.151 | 0.126 | 0.022 | 0.171 |
| 1.1 | 0.091 | 0.013 | 0.118 | 0.091 | 0.022 | 0.135 |
| 1.2 | 0.077 | 0.014 | 0.105 | 0.077 | 0.022 | 0.121 |
| 1.3 | 0.069 | 0.014 | 0.096 | 0.069 | 0.022 | 0.113 |
| 1.4 | 0.06 | 0.014 | 0.088 | 0.06 | 0.022 | 0.104 |
| 1.5 | 0.052 | 0.014 | 0.080 | 0.052 | 0.022 | 0.095 |
| 1.6 | 0.046 | 0.013 | 0.072 | 0.046 | 0.02 | 0.087 |
| 1.7 | 0.041 | 0.011 | 0.064 | 0.041 | 0.018 | 0.078 |
| 1.8 | 0.036 | 0.010 | 0.056 | 0.036 | 0.016 | 0.069 |
| 1.9 | 0.031 | 0.009 | 0.049 | 0.031 | 0.013 | 0.057 |
| 2 | 0.026 | 0.008 | 0.042 | 0.026 | 0.009 | 0.045 |
| Distal End | 0.025 | 0.008 | 0.040 | 0.025 | 0.009 | 0.042 |

As seen with reference to Table 2, the BT-250 thin (Version 2) experimental embodiment has a maximum measured wall thickness of 0.029 inches (at the proximal end), and a wall thickness of less than 0.022 inches (e.g., less than 0.02 inches) at distances of 0.4 inches and greater from the proximal end, i.e., a wall thickness of less than 0.022 inches over the entire distal body region. The disclosed pipette tip has a wall thickness at the distal end of less than 0.009 inches, e.g., in embodiments, less than 0.008, 0.006, 0.005 or 0.004 inches. In embodiments, the pipette tip has a wall thickness of from 0.02 to 0.03 over the proximal body region.

In embodiments, a wall thickness at a distance of about 0.5 inches from the proximal end is from about 0.015 to about 0.020 inches, a wall thickness at a distance of about 1.0 inch from the proximal end is from about 0.015 to about 0.020 inches, and a wall thickness at a distance of about 1.5 inch from the proximal end is from about 0.015 to about 0.020 inches.

Comparative data related to the manufacture of each of the conventional and improved design are summarized in Table 3. The data show that a 13% increase in injection pressure is associated with the thinner pipette tip, which is within machine limits, while the filling time and cooling time are reduced by 8.5% and 9.2% respectively, resulting in a total cycle time reduction per part of about 18%.

In embodiments, the pipette tip is an injection molded monolith of a single polymer or a blend of polymers (e.g., polypropylene), and has a total weight of less than 0.28 g, e.g., 0.15, 0.2 or 0.25 g, including ranges between any of the foregoing.

In embodiments, the melt flow index of the polymer(s), measured according to ASTM D1238, is between 10 and 100 g/10 min, e g, 10, 20, 30, 40, 50, 60, 70, 80, 90 and 100 g/10 min, including ranges between any of the foregoing.

TABLE 3
Moldability data

| | Max | | Time to | |
|---|---|---|---|---|
| | Injection | Filling | Reach | Part |
| | Pressure | Time | Ejection | Weight |
| | (psi) | (s) | Temp (s) | (g) |
| BT-250 | 13259 | 0.1698 | 3.26 | 0.2833 |
| BT-250 thin (ver. 2) | 14968 | 0.1555 | 2.93 | 0.1709 |
| Change | +13% | −8.5% | −9.2% | −40% |

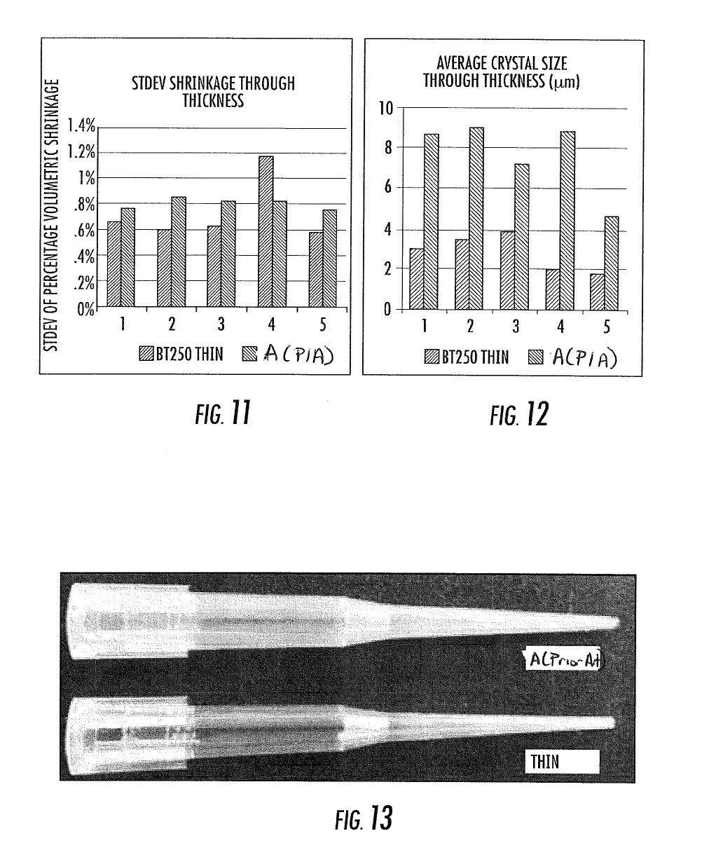

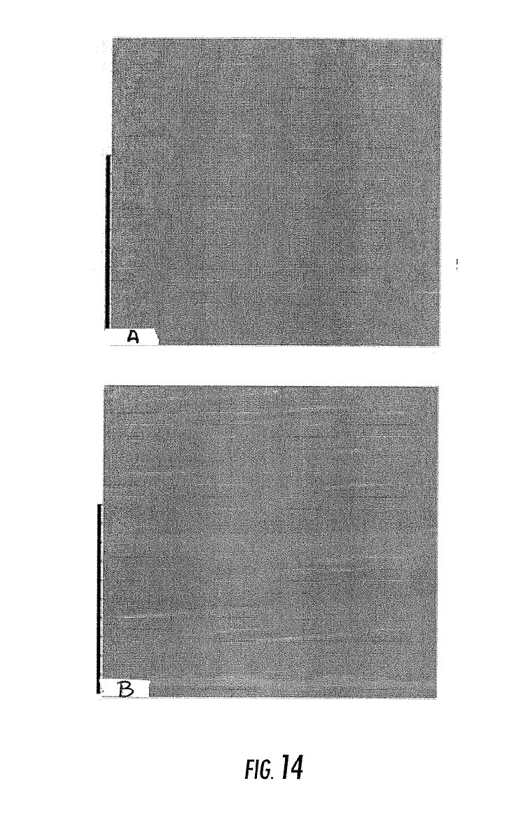

The decrease in cooling time associated with the revised (thinner walled) design results is less volumetric shrinkage, which contributes to better straightness and less warping in the final product. Data in FIG. 11 show the standard deviation in the volumetric shrinkage through the thickness of the pipette tip outer wall at various locations (1-5) for the BT-240 (thin) experimental tip and the A (Prior Art—designated as “A P/A” in FIG. 11 and FIG. 12). With respect to the A (Prior Art) pipette tip, less variation in the shrinkage was observed in four out of five of the locations tested. As seen with reference to FIG. 12, faster cooling times also result in a smaller average crystal size. In embodiments, the average crystal size in the disclosed pipette tip is less than 6 microns, e.g., 1, 2, 3, 4 or 5 microns, including ranges between any two of the foregoing. This results in a part with higher optical clarity, as illustrated in FIG. 13.

Dispense volume accuracy and precision for BT-250 and BT-250 thin tips were evaluated and compared to Beckman 250 and MBP250 tips for 10 microliter and 180 microliter dispense volumes. The results, which are shown in Table 4, reveal that the dispense volume precision for the BT-250 thin tips is comparable to the dispense volume precision of the other tips while the dispense volume accuracy for the BT-250 thin tips is markedly improved. Tips represented in Table 3 include two prior art tips, B (Prior Art) is a 250 μl pipette tip available from Beckman Coulter, Brea, Calif., and M (Prior Art) is a 250 μl pipette tip available from Molecular Bio Products available from ThermoFisher, Waltham Mass.

In embodiments, the pipette tip dispense volume accuracy is less than 0.5%, e.g., 0.3, 0.4 or 0.5%, including ranges between the foregoing, and the dispense volume precision is less than 2%, e.g., 0.5, 0.75, 1, 1.25, 1.5, 1.75 or 2%, including ranges between the foregoing.

TABLE 4
Dispense volume accuracy and precision

| | |
|---|---|
| Accuracy | Precision |

| Tip | 10 μL | 180 μL | 10 μL | 180 μL |
|---|---|---|---|---|
| BT-250 thin | 0.43% | 0.36% | 1.35% | 0.75% |
| A (Prior Art) | 0.93% | 0.89% | 1.76% | 0.70% |
| B (Prior Art) | 1.02% | 0.66% | 1.41% | 0.84% |
| M (Prior Art) | 0.74% | 1.65% | 2.28% | 0.94% |

Liquid retention for A (Prior Art) and BT-250 thin tips was evaluated and compared. In the evaluation, the initial tip mass was recorded. A glycerol, food color, water solution was drawn into each tip to its capacity and then dispensed. The final tip mass (including any residual solution) was recorded. The results (8 repeats) are summarized in Table 5 together with the average retained mass.

TABLE 5
Maximum liquid recovery

| A (Prior Art) | | | BT-250 thin | | |
|---|---|---|---|---|---|
| | | Liquid | | | Liquid |
| Initial | Final | retained | Initial | Final | retained |
| (g) | (g) | (g) | (g) | (g) | (g) |
| 0.3003 | 0.3006 | 0.0003 | 0.1868 | 0.1868 | 0.0000 |
| 0.2985 | 0.2990 | 0.0005 | 0.1859 | 0.1859 | 0.0000 |
| 0.2984 | 0.2985 | 0.0001 | 0.1850 | 0.1850 | 0.0000 |
| 0.2994 | 0.2999 | 0.0005 | 0.1864 | 0.1865 | 0.0001 |
| 0.3003 | 0.3008 | 0.0005 | 0.1852 | 0.1852 | 0.0000 |
| 0.2994 | 0.2999 | 0.0005 | 0.1833 | 0.1833 | 0.0000 |
| 0.2977 | 0.2985 | 0.0008 | 0.1837 | 0.1838 | 0.0001 |
| 0.3005 | 0.3007 | 0.0002 | 0.1826 | 0.1826 | 0.0000 |
| | | 0.0004 | | | 0.0000 |

FIG. 14 provides SEM images of the interior tip surface of the BT250 (thin) tips (shown in FIG. 14A) and the A (Prior Art) tips (which are shown FIG. 14 B) (scale bar=100 micrometers). The inner wall of the BT250 (thin) (Version 2) tip has a noticeably smoother surface than the inner wall of the A (Prior Art) tips.

Without wishing to be bound by theory, it is believed that improvements in dispense volume accuracy and precision are attributable to one or more of a relatively low interior surface roughness within the distal body region of the pipette tip, and a relatively high interior surface roughness within the proximal body region. A relatively high interior surface roughness within the proximal body region may result in an effective seal between the pipette tip and a mandrel inserted therein.

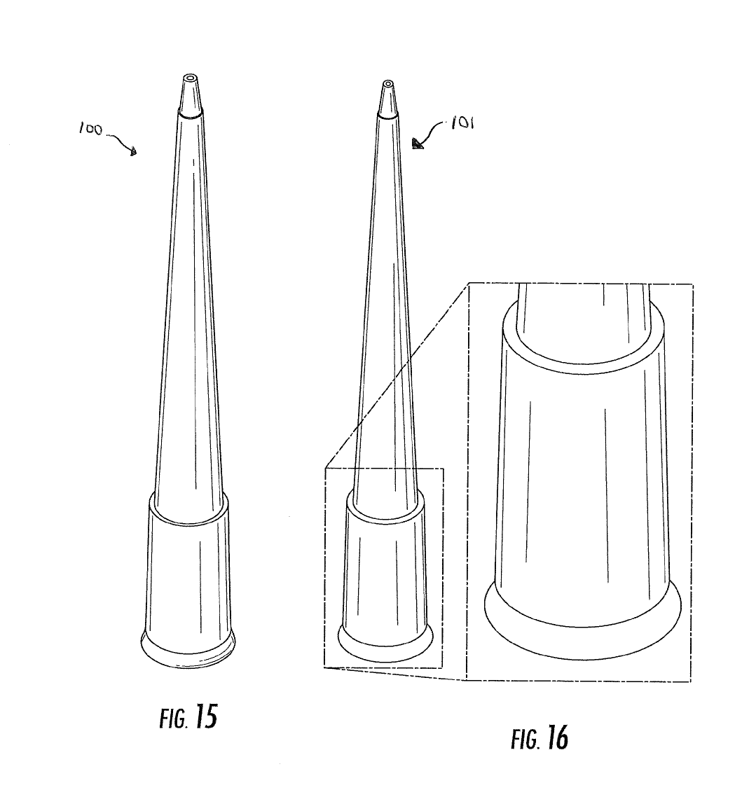

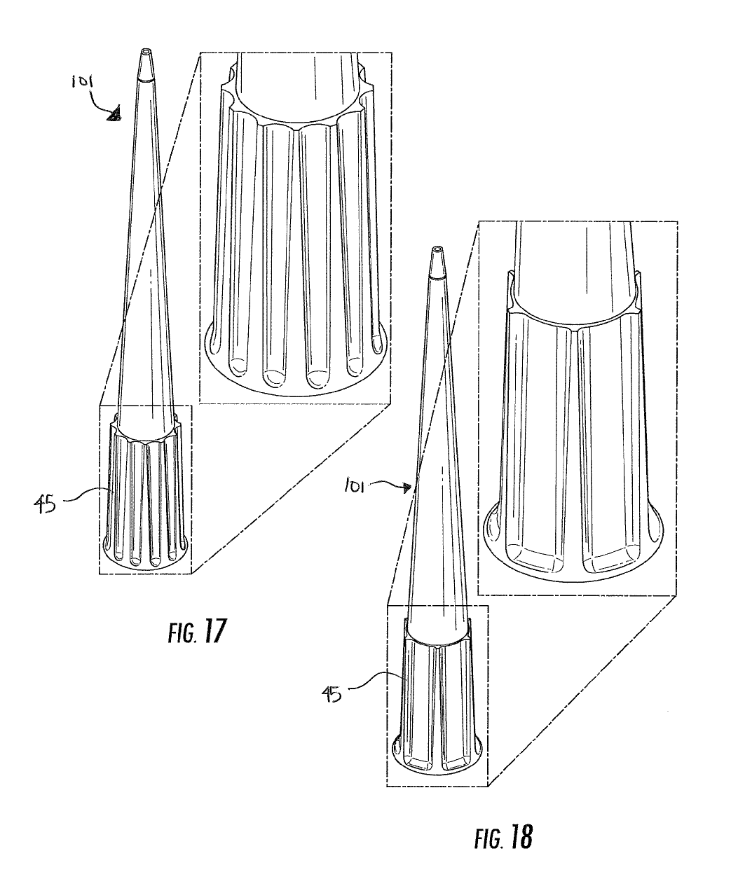

Schematic illustrations of ZT-200 pipette tips according to various embodiments are shown in FIGS. 15-18. FIG. 15 is a prior art ZT-200 tip 100, identified throughout this disclosure as A200 (Prior Art). FIG. 16 is an experimental thinned version (identified in Table 1 as ZT-200 or ZT-200 (thin) 101. FIG. 17 is an illustration of a ZT-200 or ZT-200 (thin) pipette tip 101 with ribs or fins 45, according to embodiments. FIG. 18 is a thin ZT-200 tip 100 with ribs or fins 45 according to further embodiments.

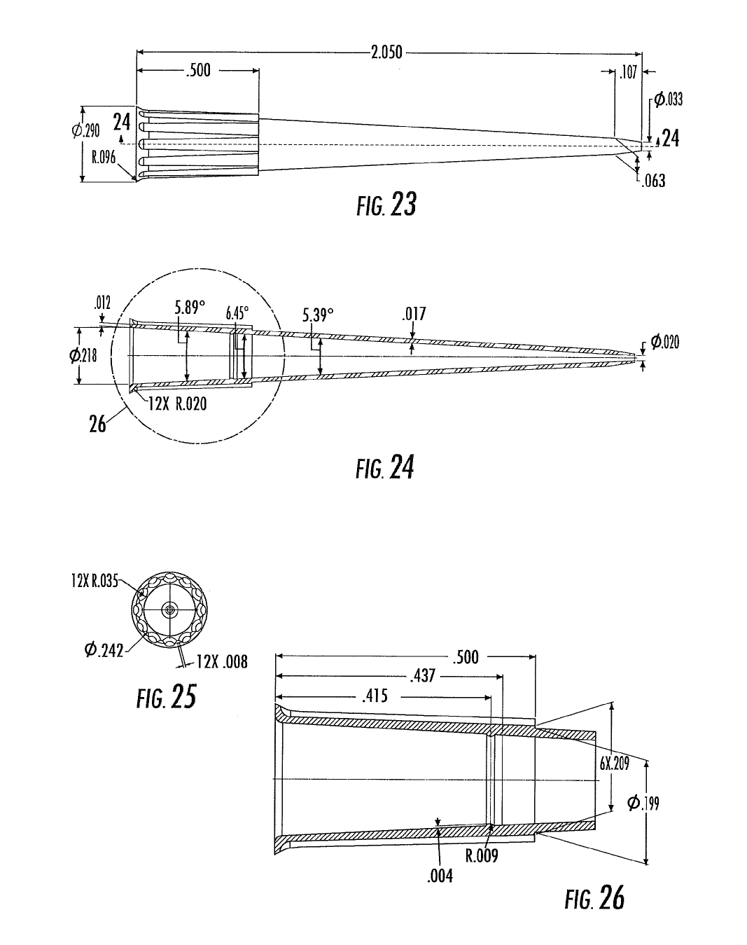

Engineering drawings for the thin ZT-200 tip of FIG. 16 are shown in FIGS. 19-22. Engineering drawings for the thin, ribbed ZT-200 tip of FIG. 17 are shown in FIGS. 23-26.

For the ZT-200 designs, resin utilization is decreased by as much as 31% relative to prior art pipette tips such as A200 (Prior Art). Compared to the A200 (Prior Art) tip (FIG. 15), embodiments of the experimental un-ribbed tip (FIGS. 16 and 19-22) uses 15% less material. Embodiments of a pipette tip with 12 ribs (FIGS. 17 and 23-26) uses 24% less material, and the embodiments of a pipette tip with 6 ribs (FIG. 18) uses 31% less material. The reduction in material provided by incorporating ribs or fins 45 may be incorporated into BT-250 pipette tip embodiments or ZT200 pipette tip embodiments, or other reduced or thinned pipette tip embodiments.

FIG. 27 is a schematic illustration of a hot runner system for manufacturing thin-walled pipette tips, according to embodiments of the invention. FIG. 27 shows a hot runner system 270 providing resin to pipette tips.

Summarized in Table 6 for different tip designs is the maximum pressure drop over the molded part during injection molding. Although the pressure drop for the referenced tips increases as material usage decreases, the total pressure drop is within machine tolerances. In embodiments, the pressure drop may range from about 3500 psi to 7000 psi. The mold temperature may range from about 35° C. to 50° C.

TABLE 6
Pressure at V/P Switchover

| | Material | Pressure | Core shift |
|---|---|---|---|
| Tip | savings | drop [psi] | [in] |
| ZT-200 thin | 15% | 3966 | 0.0000998 |
| ZT-200 thin & ribbed | 24% | 4364 | 0.0000557 |
| (12) | | | |
| ZT-200 thin & ribbed | 31% | 4581 | 0.0000822 |
| (6) | | | |
| BT-250 thin (Version 2) | 40% | 6610 | 0.0002 |

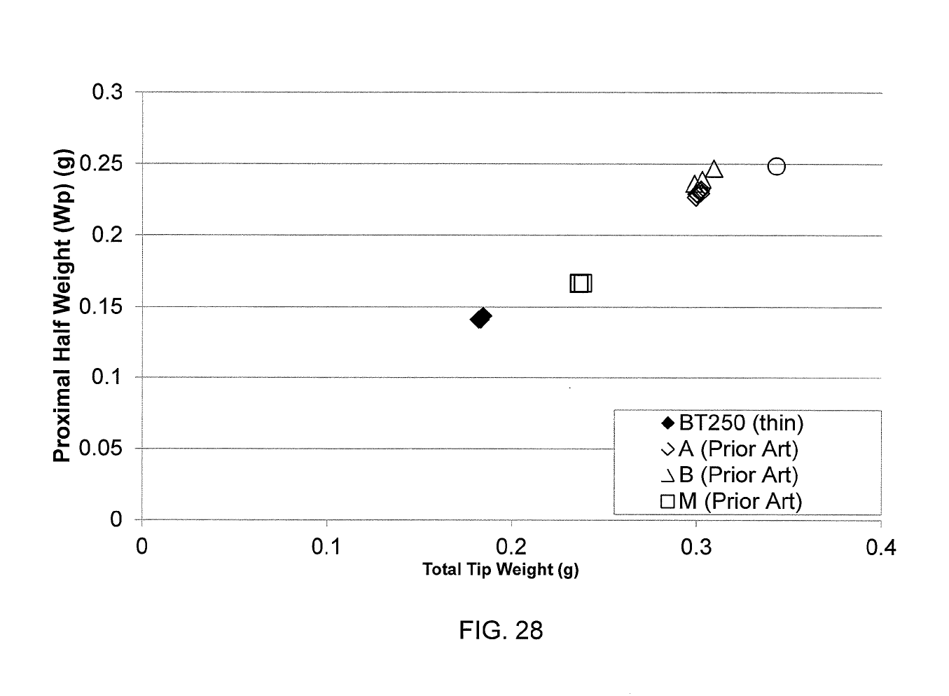

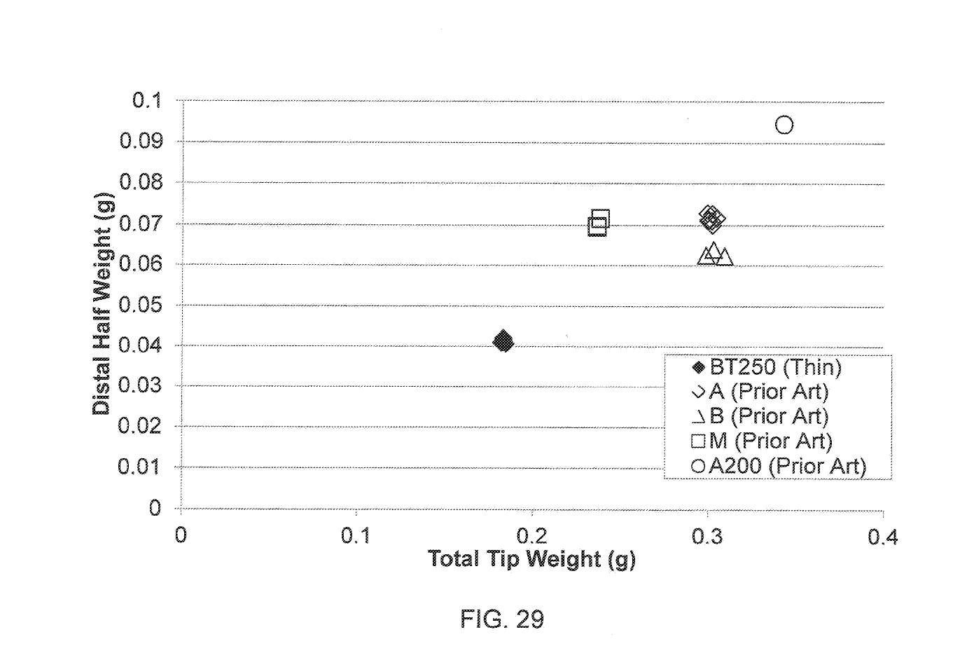

Summarized in Table 7 are measurements of tip weight taken from experimental tip BT250, and three prior art examples of pipette tips. Measurements were made of the total weight of the tip Wt, the weight of the proximal half of the tip (L/2)p, as shown in FIG. 2, the weight of the distal half of the tip (L/2)d, also shown in FIG. 2. As discussed above, the experimental tips were thinned throughout the tip, but were thinned at the distal end more than has been shown in the prior art. It was surprisingly shown that, by thinning the distal end, or in other words by reducing the weight of the distal end (Wd) of the pipette, in relation to the weight of the proximal end (Wp), a attributes can be achieved without sacrificing tip straightness, resistance to bend failures, and rigidity of the resulting tip. FIG. 28 is a graph illustrating the proximal half weight of tips compared to the total weight of the tips (Wt) for an experimental tip (BT250 (thin)) and four Prior Art tips. A200 is a 200 μl tip available from Axygen, Inc., Union City, Calif. FIG. 29 is a graph illustrating the distal half weight of tips compared to the total weight of the tips (Wt) for an experimental tip (BT 250 (thin)) and four Prior Art tips.

The ratio of the weight of the proximal end (Wp) of the pipette, in relation to the weight of the distal end (Wd), can be normalized to the total weight of each pipette tip (Wt) to define a thinning constant (T) according to Formula 1:

$$\{ \frac{( \frac{Wp}{Wd} )}{Wt} \} = T \qquad Formula 1$$

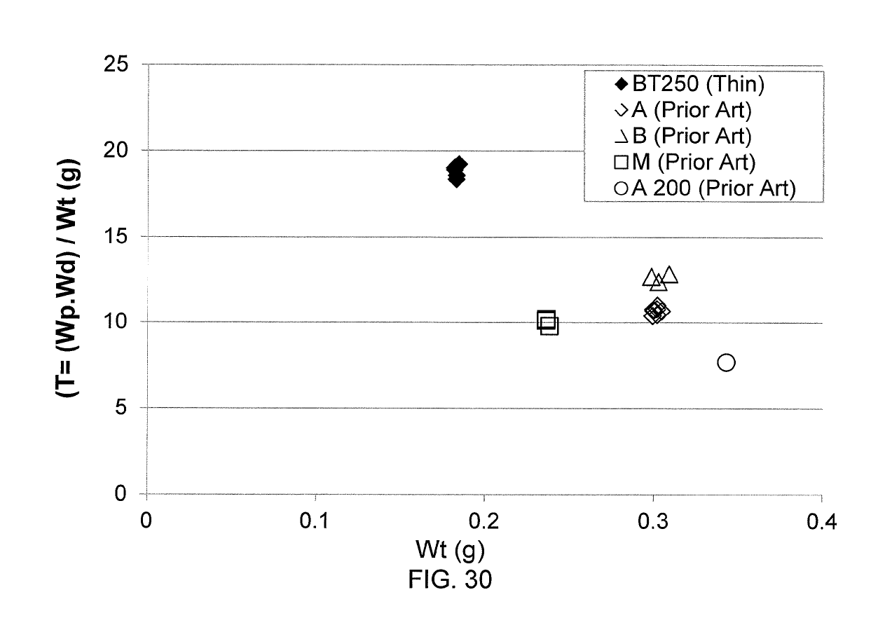

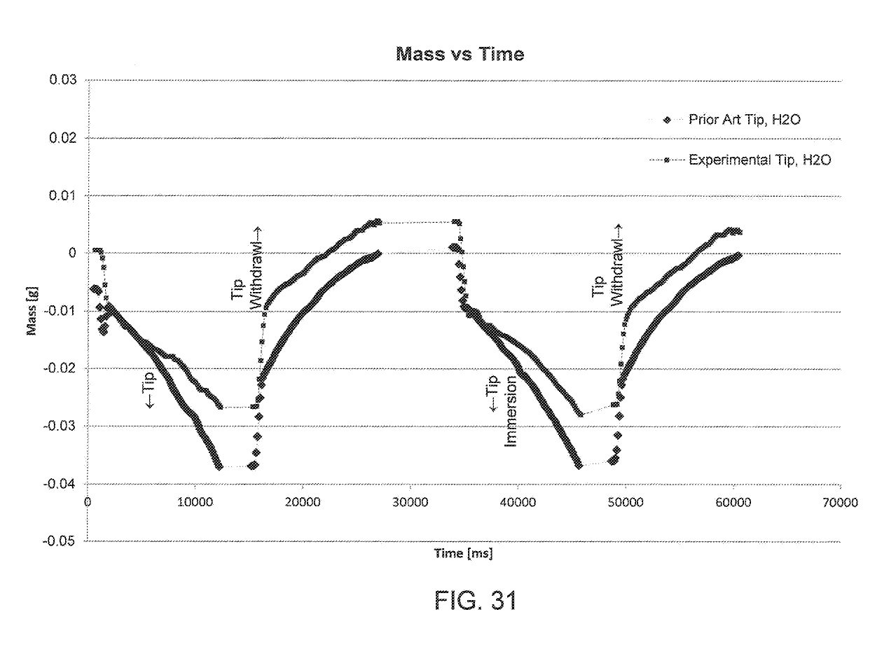

Table 6 shows measured Wd, Wp, Wt and calculated ratios of Wp:Wd, and calculated thinning constant T. FIG. 30 is a graph which plots thinning constant T against the total weight (Wt) of the illustrated pipette tips. As can be seen in FIG. 31, the experimental tip, BT 250, shows a thinning constant T that is greater than those shown for prior art pipette tips. For example, Thinning constant T can be greater than or equal to 15, greater than or equal to 16, greater than or equal to 17, or greater than or equal to 18.

TABLE 6

| Tip type | Vol (uL) | Wt (g) | Wd (g) | Wp (g) | Wp/Wd | (Wp/Wd)/Wt (T) | L (in) | L/2 (in) |
|---|---|---|---|---|---|---|---|---|
| BT 250 | 250 | 0.18 | 0.04 | 0.14 | 3.41 | 18.71 | 2.04 | 1.02 |
| A (Prior Art) | 250 | 0.3 | 0.07 | 0.23 | 3.17 | 10.56 | 2.03 | 1.015 |
| B (Prior Art) | 250 | 0.3 | 0.065 | 0.24 | 3.66 | 12.09 | 2.0225 | 1.01 |
| M (Prior Art) | 250 | 0.25 | 0.07 | 0.18 | 2.7 | 10.54 | 2.03 | 2.015 |
| A200 (Prior Art) | 200 | 0.32 | 0.08 | 0.23 | 2.77 | 8.9 | 2.045 | 1.022 |

FIG. 32 shows the interaction of the experimental tip BT 250, compared to a prior art tip (A (Prior Art), available from Axygen, Inc., Union City, Calif.). The Mass vs Time measurements, taken as the tips were immersed into water and withdrawn from water show that, as the tips are immersed in water, the prior art tip (closed diamond) has more hydrophobic characteristics than the experimental tip (closed square). Water is repelled from the tips as they are immersed into water. As the tips are withdrawn from water, the experimental tip appears to retain water, as shown by the increased mass measurement compared to the prior art tip as the tips are withdrawn from water.

Table 7 reports the measured melt peak (in degrees Celcius) and the measured area under the melt curve (J/g) as measured by Differential Scanning calorimetry (DSC). Melt Peak is a measurement that corresponds to the crystallinity of the polymer in the experimental and prior art pipette tips. BT250 and A (Prior Art) samples are manufactured from the same polymer resin. Melt Peak is a measure of the point at which crystallinity sites are broken down and the polymer melts. As shown in the Melt Peak measurements, the crystallinity of the polymer is the same for the BT250 and the A (Prior Art) tips. This indicates that the geometry of the two tips does not affect the crystallinity of the pipette tips. The Area under the Melt Peak Curve is a measurement of how much energy has to be put into the system in order to trigger the phase change of the melting polymer. The B (Prior Art) tip is made from a different polymer, having a different Melt Peak, compared to the BT250 tip and the A (Prior Art) tip. As can be seen in the differences in the measurement between the experimental BT250 (Thin) tip and the A(Prior Art) tip, the differences in geometry between the BT250 experimental tip and the A(Prior Art) tip changes the degree of crystallinity of the tip. The thinned tip has a higher degree of crystallinity (i.e. more energy has to be put in to have a phase change) compared to the prior art tip made from the same polymer material.

TABLE 7

| | | Area Under |
|---|---|---|
| | | Melt Peak Curve |
| Sample ID | Melt Peak (° C.) | (J/g) |
| BT 250 (Thin) | 162.9 | 104.5 |
| A (Prior Art) | 162.8 | 91.92 |
| B (Prior Art) | 143.9 | 58.49 |

Without being limited by theory, this difference in the crystallinity of the polymer may be a result of the molding conditions, the temperature of the molds and the polymer during the manufacturing process, or the thinness of the part itself. In addition, this difference in the crystallinity of the polymer may affect the surface roughness, the orientation of crystals, and may affect the surface tension or the hydrophilicity/hydrophobicity of the tips. Again, without being limited by theory, this difference in crystallinity may explain the wetting behavior shown in FIG. 31.

Disclosed herein are methods for designing and making pipette tips, together with the resulting pipette tips. In embodiments, the pipette tips have handling and metering dimensions that are compatible with existing infrastructure. As used herein, the singular forms “a,” “an” and “the” include plural referents unless the context clearly dictates otherwise. Thus, for example, reference to a “pipette tip” includes examples having two or more such “pipette tips” unless the context clearly indicates otherwise.

Disclosed herein is a pipette tip comprising a total weight (Wt) and a length L of between 1.75 inches and 1.24 inches comprising a proximal half (L/2)p and a distal half (L/2)d; wherein the proximal half (L/2)p has a weight Wp and the distal half (L/2)d has a weight Wd; and wherein thinning constant T, defined by Formula 1, is equal to or greater than 15, or greater than or equal to 18.

$$\{ \frac{( \frac{Wp}{Wd} )}{Wt} \} = T \qquad Formula 1$$

In addition, the disclosure provides the pipette tip described in paragraph [0098] wherein the distal half (L/2)d has a wall having a thickness of less than 0.022 inches; wherein the distal half (L/2)d wall thickness does not exceed 0.029 inches; wherein the distal half (L/2)d wall thickness is less than 0.009 inches; wherein the distal half (L/2)d wall thickness is less than 0.005 inches; or wherein the wherein the proximal half (L/2)p has a wall having a thickness of 0.02 to 0.03 inches.

In additional embodiments, the disclosure provides The pipette tip of paragraphs [0098] or [0099] wherein the pipette tip injection molded from a single polymer or a blend of polymers; wherein the average crystal size of the polymer or polymers is less than 6 microns.

In additional embodiments, the disclosure provides the pipette tip of any one of paragraphs [0098], [0099] or [0100], wherein the proximal half (L/2)p further comprising a plurality of radial fins or wherein the plurality of radial fins have a circumferential thickness of less than 0.03 inches.

In additional embodiments, the disclosure provides of any one of paragraphs [0098], [0099] [0100] or [0101] having a tip straightness differential length of less than 0.001 inches, wherein the distal half (L/2)d has an outer diameter of less than 0.2 inches or wherein the pipette tip has a total weight of less than 0.28 g.

Further, the disclosure provides a method of making the pipette tip of any one of paragraphs [0098], [0099] [0100], [0101] or [0102], comprising: injecting a polymer or a mixture of polymers into a single or multiple cavity mold, or wherein the injected polymer is polypropylene

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred. Any recited single or multiple feature or aspect in any one claim can be combined or permuted with any other recited feature or aspect in any other claim or claims.

It is also noted that recitations herein refer to a component being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a pipette tip comprising polypropylene include embodiments where a pipette tip consists of polypropylene and embodiments where a pipette tip consists essentially of polypropylene.

It will be apparent to those skilled in the art that various modifications and variations can be made to the present invention without departing from the spirit and scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

1-17. (canceled)

18. A pipette tip comprising:
an open proximal end, an open distal end, and a cylindrical outer wall extending between the open proximal end and the open distal end,
a pipette tip length from the open proximal end to the open distal end of between 1.75 inches (4.445 cm) and 2.4 inches (6.096 cm), the pipette tip length comprising a proximal half and a distal half; and
a thinning constant equal to or greater than 15, the thinning constant being defined by Formula 1:
$$\{ \frac{( \frac{Wp}{Wd} )}{Wt} \} = T \qquad Formula 1$$
wherein Wp is the weight of the proximal half of the pipette tip length in grams, Wd is the weight of the distal half of the pipette tip length in grams, Wt is the total weight of the pipette tip in grams, and T is the thinning constant in grams⁻¹.

19. The pipette tip of claim 18 wherein the T is equal to or greater than 18.

20. The pipette tip of claim 18 wherein the pipette tip length is between 1.75 inches and 2.25 inches.

21. The pipette tip of claim 18 wherein the distal half of the pipette tip length has a wall having a thickness of less than 0.022 inches.

22. The pipette tip of claim 18, wherein the wall thickness of the distal half of the pipette tip length does not exceed 0.029 inches.

23. The pipette tip of claim 18, wherein the distal half of the pipette tip length has a wall having a thickness of less than 0.009 inches.

24. The pipette tip of claim 18, wherein the distal half of the pipette tip length has a wall having a thickness of less than 0.008 inches.

25. The pipette tip of claim 18, wherein the proximal half of the pipette tip length has a wall having a thickness of between 0.02 inches and 0.03 inches.

26. The pipette tip of claim 18 wherein the pipette tip comprises a single polymer or a blend of polymers.

27. The pipette tip of claim 26, wherein the average crystal size of the polymer or polymers is less than 6 microns.

28. The pipette tip of claim 1, wherein the proximal half of the pipette tip length further comprises a plurality of radial fins.

29. The pipette tip of claim 1 having a tip straightness differential length of less than 0.001 inches.

30. The pipette tip of claim 18, wherein Wt is less than 0.28 grams.

31. A method of making the pipette tip of claim 18, the method comprising:
injecting a polymer or a mixture of polymers into a single or multiple cavity mold.

32. The method of claim 31, wherein the injected polymer is polypropylene.
